(19) United States
(12) Patent Application Publication
(10) Pub. No.: US 2012/0111786 A1
(43) Pub. Date: May 10, 2012

(54) FILTERING APPARATUS

(76) Inventor: Pi-Tang CHIANG, Taichung city (TW)

(21) Appl. No.: 13/100,608

(22) Filed: May 4, 2011

(30) Foreign Application Priority Data
Nov. 9, 2010 (TW) 99138524

(51) Int. Cl. B01D 29/54; B01D 29/11

(52) U.S. Cl. 210/238; 210/323.2; 210/232

(57) ABSTRACT

A filtering apparatus includes a container barrel and a detachable filtering unit detachably mounted inside the container barrel. The detachable filtering unit has a top lid, a bottom lid and a plurality of filter cores sandwiched between the top lid and the bottom lid. Because the filtering apparatus has the detachable filtering unit that can be totally taken out from the container barrel, the works of replacing the filter cores and washing the container barrel, especially the bottom portion of the container barrel, can be conveniently done.

### BACKGROUND OF THE INVENTION

1. Field of the Invention

The present invention relates generally to a filtering apparatus and more particularly, to a filtering apparatus having a detachable filtering unit.

2. Description of the Related Art

A conventional filtering apparatus generally comprises a container barrel and a cap covering on the container barrel. Usually, the inner wall of the container barrel is welded with a filter core mounting plate for installation thereon a plurality of filter cores. Because the filter core mounting plate is welded on the inner wall of the container barrel, when the user conducts the replacement work for the filter cores, the spent, exhausted filter cores have to be taken out from the container barrel one by one firstly, and thereafter the fresh filter cores need to be installed one by one on the filter core mounting plate again. The whole replacement work is time-consuming and labor-consuming. In addition, the sludge and/or impurities accumulated at the bottom portion of the container barrel can not be conveniently cleaned.

### SUMMARY OF THE INVENTION

The present invention has been accomplished in view of the above-noted circumstances. It is therefore one objective of the present invention to provide a filtering apparatus having a detachable filtering unit that can be taken out form the container barrel.

To achieve the above-mentioned objective, the filtering apparatus provided by the present invention comprises a container barrel and a detachable filtering unit detachably mounted inside the container barrel. The detachable filtering unit has a top lid, a bottom lid and a plurality of filter cores sandwiched between the top lid and the bottom lid. Because the detachable filtering unit is detachably mounted inside the container barrel such that it can be totally taken out from the container barrel, the filter cores can be easily replaced and the bottom portion of the container barrel can be conveniently washed.

In the filtering apparatus of the present invention, the top lid may have top lid protrusions and the bottom lid may have bottom lid protrusions corresponding one by one to the top lid protrusions and each having a through hole, such that the filter cores can be firmly mounted between the top and bottom lids.

In the filtering apparatus of the present invention, the filtering unit may further comprise a seal ring mounted around a periphery of the bottom lid and abutted against an inner surface of the container barrel to prevent unfiltered liquid from entering into a filtered liquid storage compartment in the container barrel.

In the filtering apparatus of the present invention, the filtering unit may further comprise a handle mounted on the top lid, and an upright post connected with the handle and linking the top lid with the bottom lid, such that the filter cores can be firmly clamped between the top and bottom lids.

Preferably, a structural reinforcement member is further provided having an end stopped at the bottom lid, and an opposite end stopped at the container barrel, such that the bottom lid may have a sufficient structural strength to resist deformation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded perspective view of a filtering apparatus according to a preferred embodiment of the present invention;

FIG. 2 is a cross-sectional assembly view of the filtering apparatus according to the preferred embodiment of the present invention;

FIG. 3 is an exploded cross-sectional view of a detachable filtering unit provided by the filtering apparatus of the preferred embodiment of the present invention;

FIG. 4 is a cross-sectional view, showing how the filtering apparatus of the present invention is supposed to work;

FIG. 5 is an exploded cross-sectional view showing an alternate form of the filtering unit;

FIG. 6 is a cross-sectional view, showing that the filtering unit of FIG. 5 is installed inside the container barrel;

FIG. 7 is similar to FIG. 5, but showing an alternate form of filter core is used;

FIG. 8 is a cross-sectional view, showing that the filtering unit of FIG. 7 is installed inside the container barrel, and

FIG. 9 is an exploded perspective view of the filtering unit indicated in FIG. 7.

### DETAILED DESCRIPTION OF THE INVENTION

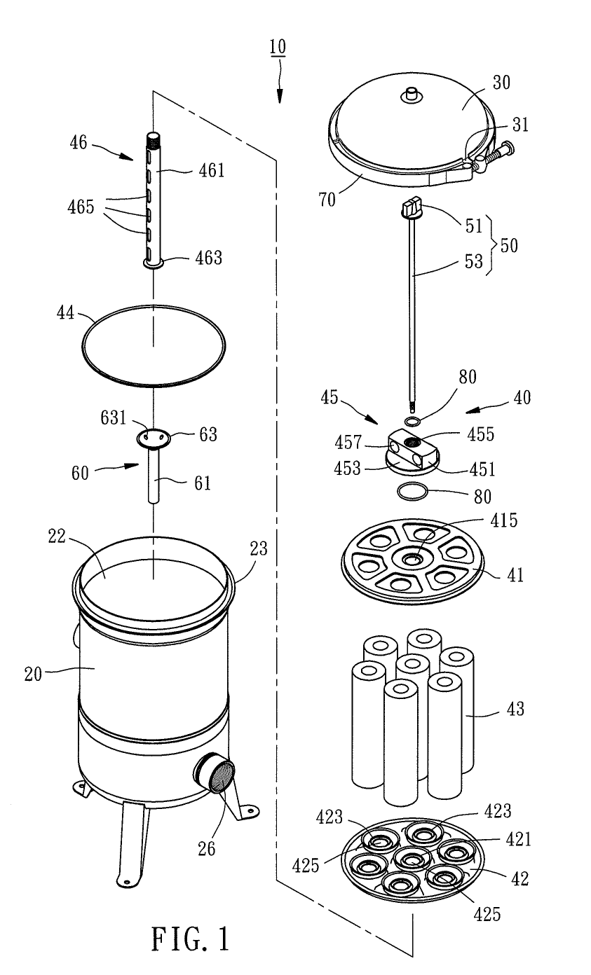

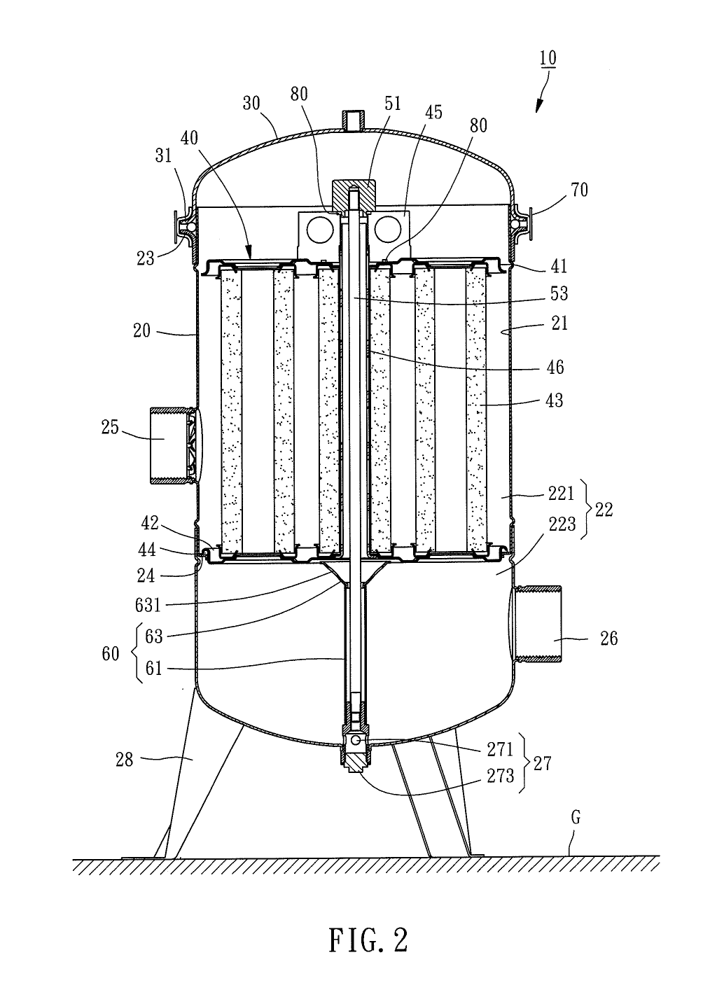

As shown in FIGS. 1-2, a filtering apparatus 10 provided according to a preferred embodiment of the present invention is mainly composed of a container barrel 20, a cap 30, a detachable filtering unit 40, a mounting rod 50, and a structural reinforcement member 60.

The container barrel 20 is made from stainless steel and shaped like a cylinder. The container barrel 20 includes an inner surface 21 of a surrounding wall, a receiving space 22 defined by the inner surface 21, and a flange 23 protruding outwardly from an outer surface of the surrounding wall at a place adjacent to a top opening of the container barrel 20. A filtering unit mounting portion 24 extends horizontally from the inner surface 21 towards a center of the container barrel 20 and divides the receiving space 22 into an upper compartment 221 for storage of unfiltered liquid and a lower compartment 223 for storage of filtered liquid. In addition, the container barrel 20 is provided with a liquid inlet 25 communicated with the upper compartment 221, and a liquid outlet 26 communicated with the lower compartment 223. A wastewater discharging member 27 is mounted at a bottommost location of the bottom portion of the container barrel 20. The wastewater discharging member 27 includes liquid discharging holes 271 located inside the lower compartment 223, and a liquid discharging valve 273 located outside the container barrel 20. Three legs 28 are equiangularly and spacedly mounted to the bottom surface of the container barrel 20 for enabling the filtering apparatus 10 to stand on the ground G stably.

The cap 30 is made from a stainless steel material and provided with a horizontally extending end edge 31. The cap 30 is capped on the top side of the container barrel 20 to prevent dust from entering into the container barrel 20. As shown in FIG. 2, a retainer 70 is provided to surround and tightly hold the end edge 31 of the cap 30 and the flange 23 of the container barrel 20 together, such that the container barrel 20 can be sealed.

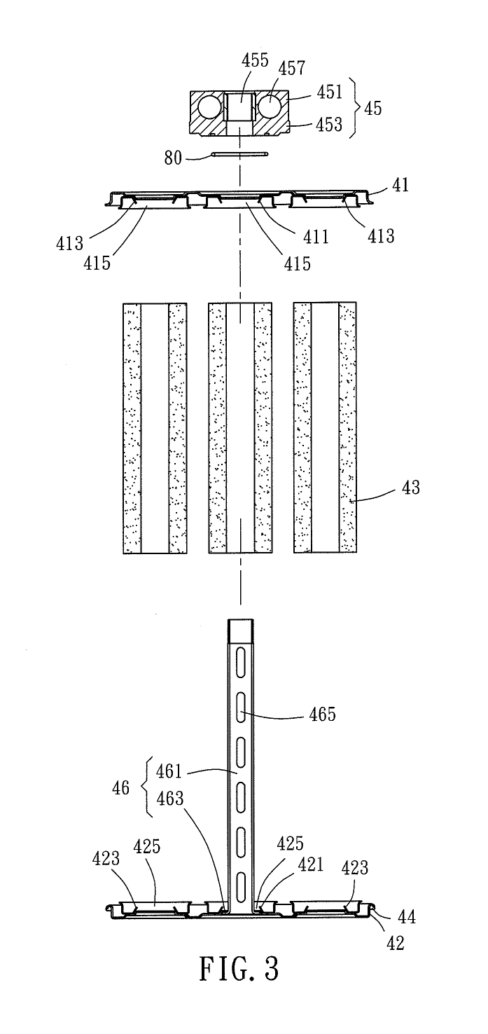

As shown in FIGS. 1, 3 and 4, the detachable filtering unit 40 is composed of a top lid 41, a bottom lid 42, seven filter cores 43, a seal ring 44, a handle 45 and an upright post 46. The top lid 41 is shaped like a round disc and provided with one center protrusion 411 and six ambient protrusions 413 equiangularly disposed on an imaginary circle surrounding the center protrusion 411. The center protrusion 411 is provided with a through hole 415. In addition, the bottom lid 42 is shaped like a round disc and provided with one center protrusion 421 and six ambient protrusions 423 equiangularly disposed on an imaginary circle surrounding the center protrusion 421. Each of the center protrusion 421 and the ambient protrusions 423 is provided with a through hole 425. The filter core 43 is formed of a cotton material having a filtering effect and shaped like a hollow cylinder. The seal ring 44 is a round cushion pad having a sealing effect. The handle 45 has a grip portion 451, a round bottom portion 453 and a threaded through hole 455 penetrating through the grip portion 451 and the bottom portion 453. The grip portion 451 of the handle 45 is provided with two through holes 457 for insertions of user's fingers to facilitate the user to grip and take the filtering unit 40. The upright post 46 is a hollow post having a shank 461 and a bottom 463. The shank 461 of the upright post 46 has a threaded top portion and a plurality of through holes 465 for the passing of filtered liquid L_{f}.

In assembly of the filtering unit 40, as shown in FIGS. 1-2, the filter cores 43 are installed between the top lid 41 and the bottom lid 42 in such a way that the top lid protrusions 411 and 413 and the bottom lid protrusions 421 and 423 are inserted respectively into two ends of the filter cores 43 and the upright post 46 extends through the through hole 425 of the center protrusion 421 of the bottom lid 42, passes through the center one of the filter cores 43 and the through hole 415 of the center protrusion 411 of the top lid 41, and is threaded with the threaded through hole 455 of the handle 45. By means of the aforesaid screwing connection, the top lid 41 and the bottom lid 42 can be forced to move toward each other so as to firmly clamp the filter cores 43 therebetween. In addition, the seal ring 44 is sleeved on a periphery of the bottom lid 42. Further, in order to firmly connect the handle 45 with the top lid 41, filter cores 43, bottom lid 42 and the upright post 46 in sequence and to prevent the unfiltered liquid filled in the upper compartment 221 from flowing into the lower compartment 223 through the upright post 46 without passing through the filter cores 43, an O-ring 80 is provided between the handle 45 and the top lid 41. It will be appreciated that the upright post 46 can be, in practice, welded with the bottom lid 42 directly.

The mounting rod 50 has a driven tab 51 and a rod-like shank 53 connected with the driven tab 51 and provided at a bottom portion thereof with a thread.

The structural reinforcement member 60 is formed of a hollow tube having a shank 61 and a flared head 63 that flares from the top of the shank 61. The flared head 63 has a plurality of through holes 631 for the passing of filtered liquid L_{f}. The structural reinforcement member 60 can provide an additional support force to the bottom lid 42 to prevent the bottom lid 42 from deformation caused by the enhanced pressure of the unfiltered liquid in the upper compartment 211 due to the deterioration of filtering effect of the filter cores, which may happen after a long time of use to further result in that the unfiltered liquid Lᵤ in the upper compartment 221 can not be normally filtered.

In assembly of the filtering apparatus 10, as shown in FIG. 2, the shank 61 of the structural reinforcement member 60 is threaded with the wastewater discharging member 27, the detachable filtering unit 40 is placed on the filtering unit mounting portion 24 of the container barrel 20 with the seal ring 44 abutting against the filtering unit mounting portion 24, the flared head 63 of the structural reinforcement member 60 supports the bottom lid 42 of the filtering unit 40, and the shank 53 of the mounting rod 50 is inserted through the filtering unit 40 and the structural reinforcement member 60 and threaded with the wastewater discharging member 27 with the driven tab 51 abutting against the handle 45. In this way, the filtering unit 40 can be firmly mounted inside the container barrel 20. Similarly, in order to firmly mount the detachable filtering unit 40 to the container barrel 20 and to prevent the unfiltered liquid Lᵤ filled in the upper compartment 221 from flowing into the lower compartment 223 through the upright post 46 without passing through the filter cores 43, an O-ring 80 can be provided between the driven tab 51 of the mounting rod 50 and the handle 45.

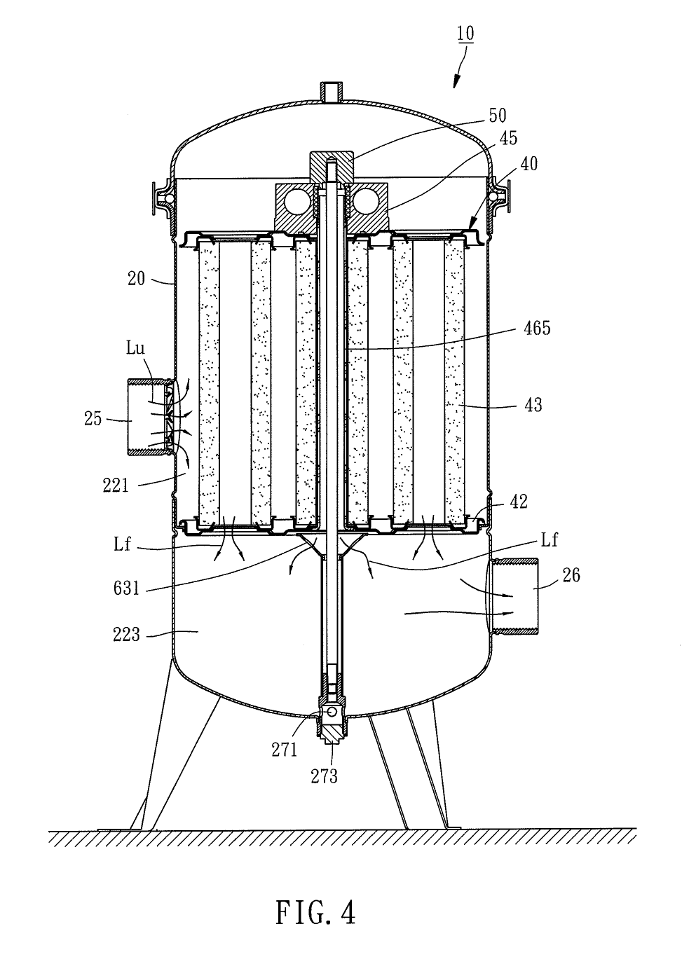

As shown in FIG. 4, when the filtering apparatus 10 of the present invention is in operation, the unfiltered liquid Lᵤ streaming through the liquid inlet 25 of the container barrel 20 will enter the upper compartment 221 of the receiving space 22 of the container barrel 20 and then be filtered by the filter cores 43 to become filtered liquid L_{f}. The filtered liquid L_{f} treated by the ambient filter cores 43 will enter the lower compartment 223 for storage of the filtered liquid through the through holes 425 of the ambient protrusions 423 of the bottom lid 42, and the filtered liquid L_{f} treated by the center filter core 43 will flow into the structural reinforcement member 60 through the through holes 465 of the shank 461 of the upright post 46 and then enter the lower compartment 223 through the through holes 631 of the structural reinforcement member 60. The filtered liquid L_{f} can eventually be discharged out from the lower compartment 223 through the liquid outlet 26 of the container barrel 20.

To replace the filter cores 43, the user can open the cap 30 and loosen and then take the mounting rod 50 out, such that the whole filtering unit 40 can be taken out from the container barrel 20 to facilitate the replacement of the filter cores 43. To wash the container barrel 20, the filtering unit 40 can be taken out from the container barrel 20 by the aforesaid method to facilitate the cleaning treatment of the sludge and/or impurities accumulated at the bottom portion of the container barrel 20. After completion of the cleaning washing, wastewater can be discharged out of the container barrel 20 through the liquid discharging hole 271 by opening the liquid discharging valve 273.

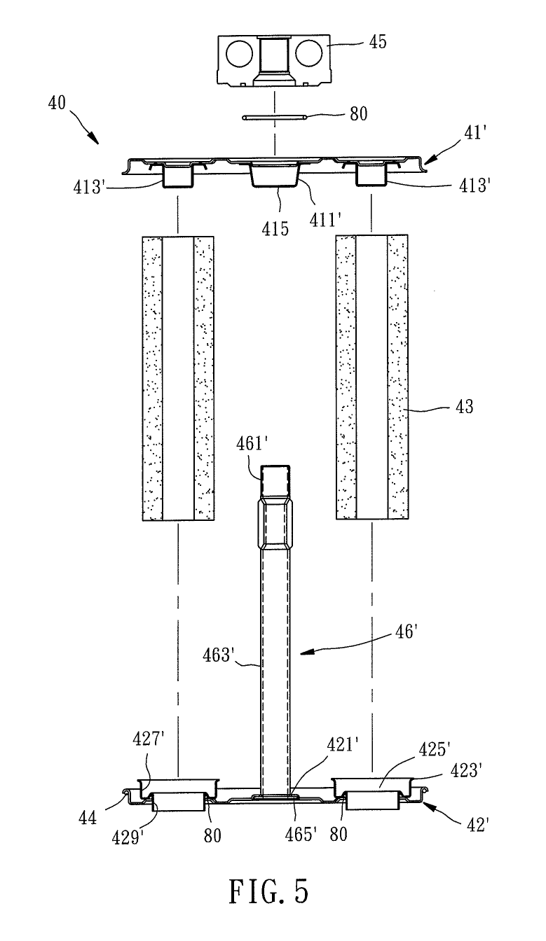

Referring to FIGS. 5-9, the detachable filtering unit used in the present invention may have various alternate forms as disclosed in FIGS. 5, 7 and 9, to fit various kinds of commercial available filter core.

Specifically speaking, the detachable filtering unit 40 shown in FIGS. 5-9 is composed of a top lid 41′, a bottom lid 42′, six filter cores 43 or 43′, a seal ring 44, a handle 45 and an upright post 46′.

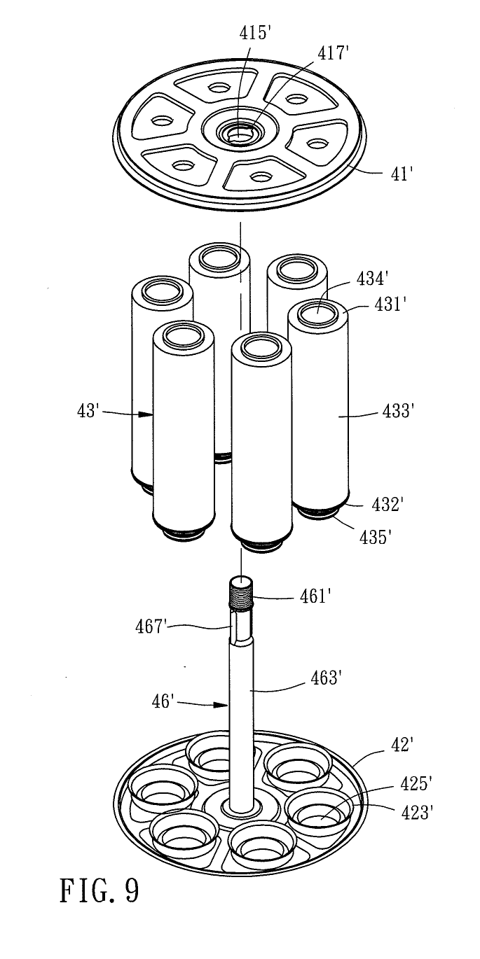

The top lid 41′ is shaped like a round disc and provided with one center protruding column 411′ and six ambient protruding columns 413′ equiangularly disposed on an imaginary circle surrounding the center protruding column 411′. The center protruding column 411′ is provided with a through hole 415′. As shown in FIG. 9, the top lid 41′ has two opposite restriction portions 417′ located at the through hole 415′ of the protruding column 411′ and formed by two recesses of a wall defining the through hole 415′.

The bottom lid 42′ is shaped like a round disc and provided with one center through hole 421′ and six filtering core supporting discs 423′ equiangularly disposed on an imaginary circle surrounding the center through hole 421′. Each of the filter core supporting discs 423′ is provided with a through hole 425′ having a relatively large diameter section 427′ and a relatively small diameter section 429′. In practical manufacturing, the filter core supporting discs 423′ are fixed on the base of the bottom lid 42′ by spot welding. An O-ring 80 is disposed between each filter core supporting disc 423′ and the base of the bottom lid 42′ to prevent the unfiltered liquid Lᵤ from entering the lower compartment 223 that is adapted for storage of the filtered liquid through the gap between each filter core supporting disc 423′ and the base of the bottom lid 42′.

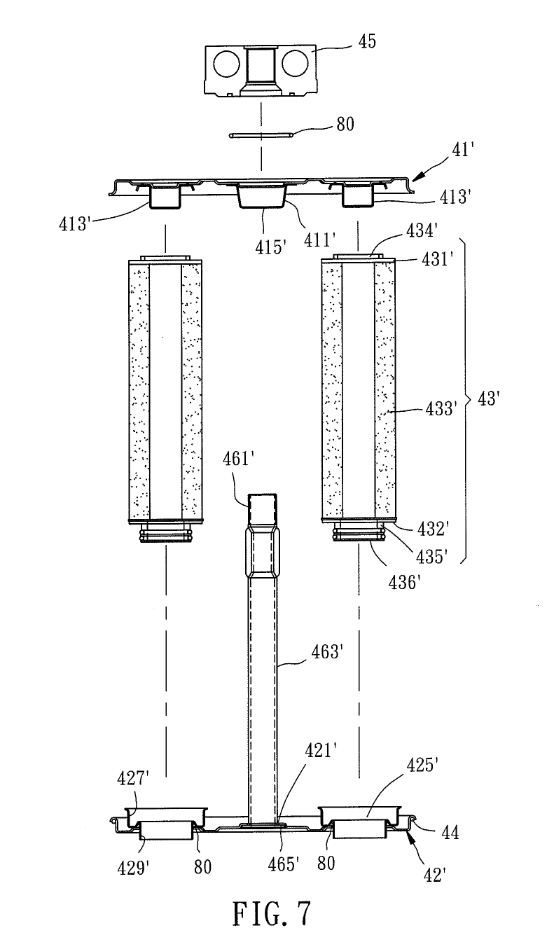

As shown in FIG. 5, the filter core 43 is formed of a cotton material having a filtering effect and shaped like a hollow cylinder, which is the same as the filter core disclosed in FIG. 1. On the other hand, the filter core 43′ shown in FIGS. 7-9 has a top cover 431′, a bottom cover 432′ and a hollow cotton filtering body 433′ clamped between the top and bottom covers 431′ and 432′. Each top cover 431′ is provided with a restriction recess 434′ and each bottom cover 432′ is provided with a protrusion 435′ with a through hole 436′ communicated with the hollow portion of the cotton filtering body 433′.

In FIGS. 5-9, the configurations of the seal ring 44 and the handle 45 remain the same as the disclosures in FIGS. 1-4.

The upright post 46′ is a hollow post having a head 461′, a shank 463′ and a bottom 465′. The head 461′ is provided with a thread. The shank 463′ has two opposite ribs 467′ adjacent to the head 461′. In practical manufacturing, the upright post 46′ is welded on the bottom lid 42′ in such a way that the head 461′ and the shank 463′ extend through the center through hole 421′ of the bottom lid 42′.

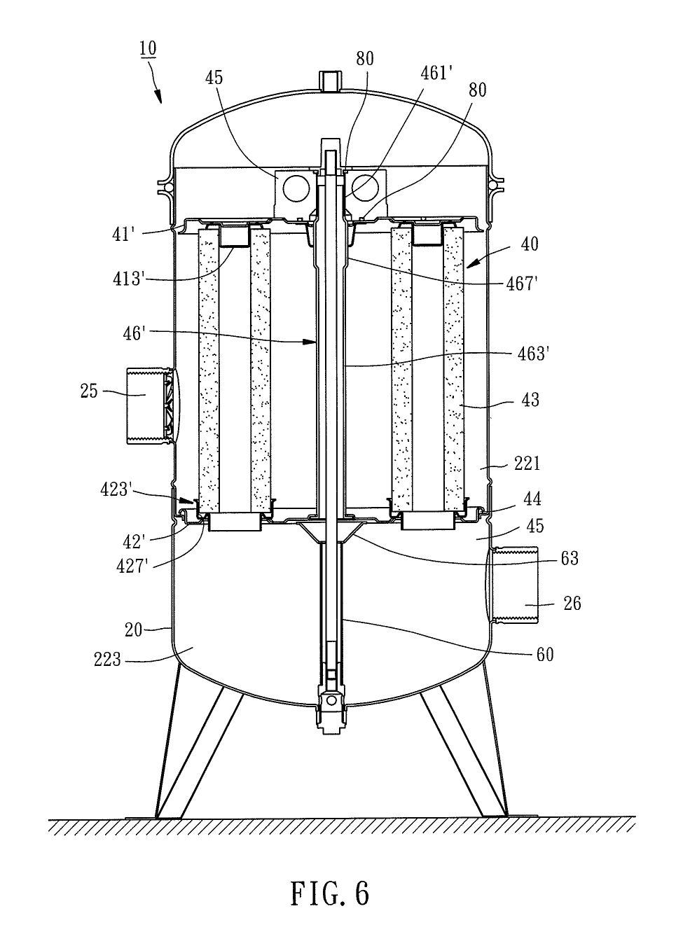

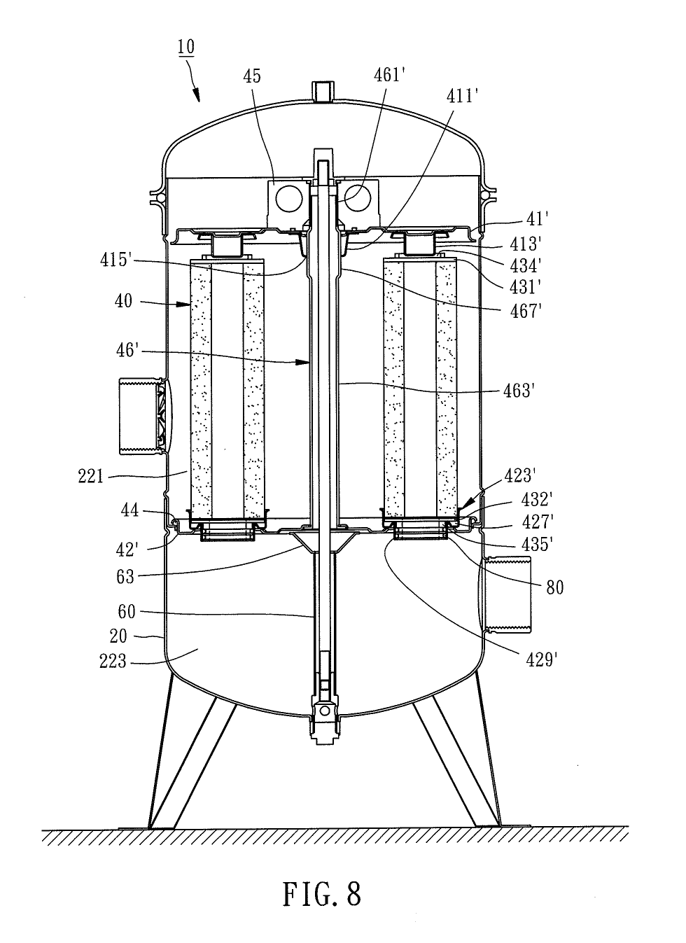

In assembly of the filtering unit 40′, as shown in FIG. 6, the filter cores 43 are installed between the top lid 41′ and the bottom lid 42′ in such a way that the ambient protruding columns 413′ of the top lid 41′ are inserted respectively into top ends of the filter cores 43 and the bottom ends of the filter cores 43 are respectively received in the relatively large diameter sections 427′ of the filter core supporting discs 423′. Alternatively, as shown in FIG. 8, the filter cores 43′ are installed between the top lid 41′ and the bottom lid 42′ in such a way that the ambient protruding columns 413′ of the top lid 41′ are respectively received in the restriction recesses 434′ of the top cover 431′ of the filter core 43′, the protrusions 435′ of the bottom cover 432′ are respectively inserted into the relatively small diameter sections 429′ of the filter core supporting discs 423′, and the bottom covers 432′ of the filter cores 43′ are respectively received in the relatively large diameter sections 427′ of the filter core supporting discs 423′. Two O-rings 80 are sleeved onto the protrusion 435′ of the bottom cover 432′ of each filter core 43′ to enable the filter core 43′ to be firmly fitted in the relatively small diameter section 429′ of the filter core supporting disc 423′.

Besides, the head 461′ of the upright post 46′ extends through the through hole 415′ of the center protruding column 411′ of the top lid 41′ and is treaded with the threaded through hole 455 of the handle 45. By means of the aforesaid screwing connection, the top lid 41′ and the bottom lid 42′ can be forced to move toward each other so as to firmly clamp the filter cores 43 or 43′ therebetween. In addition, the ribs 467′ of the shank 463′ of the upright post 46′ are respectively received in the restriction portions 417′. After the replacement work for the filter cores 43 or 43′ is completed, the top lid 41′ can be positively assembled on the top sides of the filter cores 43, 43′ by coupling the restriction portions 417′ of the top lid 41 with the ribs 467′ of the upright post 46′ to facilitate the ambient protruding columns 413′ of the top lid 41′ to be in alignment with the filter cores 43, 43′. In other words, the detachable filtering unit 40 can be assembled positively, quickly and conveniently. Further, the seal ring 44 is sleeved on a periphery of the bottom lid 42′. Furthermore, in order to firmly connect the handle 45 with the top lid 41′, filter cores 43 or 43′, bottom lid 42′ and the upright post 46′ in sequence and to prevent the unfiltered liquid Lᵤ filled in the upper compartment 221 from flowing into the lower compartment 223 through the upright post 46′ without passing through the filter cores 43, 43′, an O-ring 80 is provided between the handle 45 and the top lid 41′. It will be appreciated that the upright post 46 can be, in practice, welded on the bottom lid 42 directly.

Providing that the filtering unit 40 is constructed as the disclosures indicated in FIGS. 5-9, the through holes 631 of the flared head 63 of the structural reinforcement member 60 can be eliminated. Further, a pressure gauge can be further provided on, for example the cap 30 of the filtering apparatus 10 of the present invention. By means of monitoring the liquid pressure through the pressure gauge, whether the filtering efficiency of the filter cores falls in a normal range can be learned, such that the exact timing of replacing the spent, exhausted filter cores can be obtained.

In conclusion, since the filtering unit of the filtering apparatus of the present invention is detachably installed inside the container barrel and can be taken out from the container barrel conveniently, the replacement work for filter cores can be easily done and sludge and/or impurities accumulated at the bottom portion of the container barrel can be conveniently cleaned.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A filtering apparatus, comprising:
a container barrel, and
a detachable filtering unit detachably mounted inside the container barrel and provided with a top lid, a bottom lid and a plurality of filter cores sandwiched between the top lid and the bottom lid.

2. The filtering apparatus of claim 1, wherein the container barrel comprises a filtering unit mounting portion on which the filtering unit is mounted.

3. The filtering apparatus of claim 2, wherein the filtering unit mounting portion of the container barrel extends horizontally from an inner surface of the container barrel towards a center of the container barrel.

4. The filtering apparatus of claim 1, wherein the filtering unit comprises a seal ring mounted around a periphery of the bottom lid and abutted against an inner surface of the container barrel.

5. The filtering apparatus of claim 1, wherein the top lid comprises a plurality of top lid protrusions and the bottom lid comprises a plurality of bottom lid protrusions corresponding one by one to the top lid protrusions and each having a through hole; one of said top lid protrusions and respective one of said bottom lid protrusions are inserted into two ends of one of said filter cores respectively.

6. The filtering apparatus of claim 5, wherein the detachable filtering unit comprises a handle and an upright post connected with the handle and linking the top lid with the bottom lid; the detachable filtering unit is able to be taken out from the container barrel by the handle.

7. The filtering apparatus of claim 6, wherein the upright post comprises a bottom mounted to the bottom lid, and a shank extending through the through hole of the bottom lid protrusion that is located at a center of the bottom lid, one of the filter cores and a through hole of the top lid protrusion that is located at a center of the top lid, and being connected with the handle.

8. The filtering apparatus of claim 7, wherein the upright post is a hollow post having a plurality of through holes on the shank thereof.

9. The filtering apparatus of claim 1, wherein the top lid comprises a plurality of protruding columns and the bottom lid comprises a plurality of filter core supporting discs corresponding one by one to the protruding columns and each having a through hole; each of the filter cores is disposed between one of the protruding columns and the respective one of the filter core supporting discs in a way that the one of the protruding columns is inserted into an end of the filter core and the respective one of the filter core supporting discs supports the other end of the filter core.

10. The filtering apparatus of claim 9, wherein the detachable filtering unit comprises a handle and an upright post connected with the handle and linking the top lid with the bottom lid; the detachable filtering unit is able to be taken out from the container barrel by the handle.

11. The filtering apparatus of claim 10, wherein the upright post comprises a bottom mounted to the bottom lid, a head connected with the handle, and a shank between the bottom and the head; the shank of the upright post extends through the through hole located at a center of the bottom lid and a through hole of the protruding column that is located at a center of the top lid.

12. The filtering apparatus of claim 11, wherein the shank of the upright post is provided with two ribs adjacent to the head of the upright post, and the top lid has two restriction portions located at the through hole of the protruding column and formed by two recesses of a wall defining the through hole of the protruding column; wherein the two ribs are received in the two restriction portions respectively.

13. The filtering apparatus of claim 11, wherein the upright post is a hollow post having a plurality of through holes on the shank thereof.

14. The filtering apparatus of claim 1, further comprising a structural reinforcement member having an end stopped at the bottom lid, and an opposite end stopped at the container barrel.

15. The filtering apparatus of claim 14, wherein the structural reinforcement member is a hollow tube having a shank mounted to the container barrel, and a flared head flaring from the shank and having through holes; wherein the flared head of the structural reinforcement member is stopped at the bottom lid.
